(19) United States
(12) Patent Application Publication
(10) Pub. No.: US 2025/0249814 A1
(43) Pub. Date: Aug. 7, 2025

(54) HIGH LIFT UTILITY VEHICLE

(71) Applicant: The Toro Company, Bloomington, MN (US)

(72) Inventors: Derek D. Balzer, Burnsville, MN (US); Patrick J. Clint, Minneapolis, MN (US)

(21) Appl. No.: 19/042,863

(22) Filed: Jan. 31, 2025

Related U.S. Application Data
(60) Provisional application No. 63/549,892, filed on Feb. 5, 2024.
(60) Provisional application No. 63/549,135, filed on Feb. 2, 2024.

(51) Int. Cl. B60P 1/34; B60P 1/16

(52) U.S. Cl. CPC B60P 1/34; B60P 1/16

(57) ABSTRACT

A compact utility vehicle including a material transporting system with improved lifting and dumping capabilities. The compact utility vehicle includes a lift assembly situated between a chassis and a hopper including a scissor linkage assembly comprising a pivotably interconnected first and second member. Each of the first and second members ends are respectively coupled to the chassis and the hopper, using roller and track assemblies. The lift assembly enabling the hopper to shift forward as it rises, optimizing weight distribution and enhancing stability during the transition from storage to dump position. Additionally, the compact utility vehicle incorporates a dump linkage configured to pivot the hopper from storage to dump position, facilitating efficient unloading into a standard-height dumpster or other high walled container.

### RELATED APPLICATIONS

This application claims priority to U.S. Provisional Application Ser. No. 63/549,892, filed on Feb. 5, 2024; and claims priority to U.S. Provisional Application Ser. No. 63/549,135, filed Feb. 2, 2024, the entireties of each of which are incorporated herein by reference.

### TECHNICAL FIELD

The present invention generally relates to powered material transporting vehicles, and more particularly compact utility vehicles including lift and dump assemblies for improved handling and disposal capabilities.

### BACKGROUND

In the realm of powered material transporting vehicles, specifically utility vehicles, their usage spans a broad spectrum of applications, prominently including landscaping and maintenance tasks. These vehicles are engineered for versatility and efficiency, often equipped with features like hoppers or beds for carrying various materials, ranging from gardening supplies and soil to construction debris and waste. A common task assigned to these vehicles is the transportation of materials to and from sites, with a frequent endpoint being a dumpster for waste disposal or material recycling.

Dumpsters, being the conventional receptacles for waste and material disposal in many industrial and commercial settings, vary in their design and dimensions. Notably, the height of a standard dumpster's edge often exceeds four feet above the ground, which poses a challenge for utility vehicles, especially when tasked with lifting and unloading heavy materials. The act of raising these materials to the height required for successful disposal into dumpsters necessitates a robust and stable lifting mechanism.

However, many current utility vehicle designs encounter limitations in this aspect. Lifting heavy loads to such heights can not only strain the vehicle's mechanical systems but also compromise its stability. The higher the load is lifted, the more the vehicle's center of gravity shifts, which may lead to decreased stability. This is particularly problematic when the vehicle is required to maneuver in uneven terrain or under conditions where stability is already decreased.

### SUMMARY

Aspects of the present disclosure relate to a compact utility vehicle with enhanced functionality in lifting and dumping operations. In embodiments, the compact utility vehicle can be equipped with a lift assembly positioned between a chassis and a hopper (or a frame supporting the hopper). For example, the lift assembly can be a scissor linkage assembly, comprising a first and a second member pivotably connected to each other. The scissor linkage assembly can be configured such that one end of each member is pivotably or slidingly coupled to the chassis and the hopper respectively, utilizing roller and track assemblies. Further, a structure of the scissor linkage assembly can facilitate a forward shift of the hopper towards the target dumping area as the hopper is elevated from a lower to a higher position, which can be beneficial in ensuring that the contents of the hopper adequately clear the dumpster wall.

In some embodiments, the compact utility vehicle can additionally include a dump linkage integrated into a frame supporting the hopper. The dump linkage can be designed to pivot the hopper from a storage to a dump position, enabling efficient unloading of contents into a standard height dumpster. The dump linkage can include two members and can be powered by an actuator.

In some embodiments, the compact utility vehicle can be an electrically powered vehicle, including a power source for an electric motor, which in turn can drive a hydraulic pump. The hydraulic pump can power one or more actuators to respectively actuate the lift and dump assemblies through their respective ranges of motion as well as one or more hydraulic motors as a prime mover for driving the vehicle's wheels or tracks. The vehicle's wheels or tracks can also be powered by electric motors, as is presented in the drawings.

One aspect of the present disclosure relates to a compact utility vehicle, including a chassis extending along a longitudinal axis and carrying a prime mover and ground engaging wheels or tracks, a lift assembly supported by the chassis and being movable between a lowered position and a raised position via a first actuator, the lift assembly including a scissor linkage assembly supported by the chassis via a track and a fixed first pivot joint, and a hopper supported by the lift assembly and being pivotable with respect to the lift assembly between a dump position and a storage position via a second actuator.

In one embodiment, a compact utility vehicle can further include a control arrangement configured to actuate the first and second actuators to selectively raise and lower the lift assembly between the lowered and raised positions, and to pivot the hopper between the storage and dump positions based on a user input.

In one embodiment, the scissor linkage assembly includes a first member pivotally connected to a second member, the first member being pivotally connected to the chassis at the first pivot joint, the second member being supported by the track. In one embodiment, a first transverse axis, extending through the first pivot joint, is vertically lower than a second transverse axis extending through an end of the second member proximate the track. In one embodiment, the second horizontal transverse axis is located vertically higher than the first horizontal transverse axis at least when the lift assembly is in the lowered position. In one embodiment, the first member is a single first member and the second member includes two second members pivotally connected to opposite sides of the single first member.

In one embodiment, a front edge of the hopper moves in a first direction when the lift assembly is operated from the lowered position towards the raised position, and wherein the front edge of the hopper moves in the first direction when the hopper is operated from the storage position to the dump position. In one embodiment, a front edge of the hopper is moved at least 1 inch in the first direction from the lowered position to the raised position and is moved at least 1 inch in the first direction between the storage position to the dump position. In one embodiment, the front edge of the hopper is moved at least 24 inches in a vertical direction from the lowered position to the raised position.

Another embodiment of the present disclosure provides a compact utility vehicle, including a chassis extending along a longitudinal axis and carrying a prime mover and ground engaging wheels or tracks, a rear standing platform proximate a rear of the chassis, a lift assembly supported by the chassis and being movable between a lowered position and a raised position via a first actuator, the lift assembly including a scissor linkage assembly supporting a frame, a hopper supported by the frame and being pivotable with respect to the frame between a dump position and a storage position via a second actuator, and a control console at the rear of the chassis, the control console including a control arrangement configured to actuate the first and second actuators to selectively raise and lower the hopper and to pivot the hopper between the storage and dump positions based on a user input.

In one embodiment, the frame has a front face that is forward of a front face of the chassis when the lift assembly is in the raised position, and wherein the front face of the frame is rearward of the front face of the chassis when the lift assembly is in the lowered position. In one embodiment, the scissor linkage assembly includes a first member pivotally connected to a second member at a first connection point. In one embodiment, the first actuator is connected between a front portion of the chassis and a location coaxially aligned with the first connection point of the lift assembly.

In one embodiment, the first member includes a first end pivotally connected to the chassis and a second end supported by a first track associated with the frame, and wherein the second member includes a first end supported by a second track associated with the chassis and a second end pivotally connected to the frame. In one embodiment, one or both of the first and second tracks is sloped relative to the longitudinal axis.

In one embodiment, the compact utility vehicle further includes a dump linkage including a first member pivotally connected to a second member, wherein the first member is pivotally connected to the frame and the second member is pivotally connected to the hopper. In one embodiment, the second actuator includes a first end pivotally connected to the frame and a second end pivotally connected to the dump linkage second member. In one embodiment, the hopper includes a sloped bottom surface and the frame includes a sloped upper surface, wherein when the hopper is in the storage position, the hopper sloped bottom surface is parallel to the frame sloped upper surface.

Another aspect of the present disclosure provides a compact utility vehicle, including a chassis extending along a longitudinal axis and carrying a prime mover and ground engaging wheels or tracks, a lift assembly supported by the chassis and being movable between a lowered position and a raised position via a first actuator, the lift assembly including a scissor linkage assembly supported by the chassis via a spring-biased roller and track arrangement and at a fixed first pivot joint, a hopper supported by the lift assembly and being pivotable with respect to the lift assembly between a dump position and a storage position via a second actuator, and a control arrangement configured to actuate the first and second actuators to selectively raise and lower the hopper and to pivot the hopper between the storage and dump positions based on a user input.

In one embodiment, the scissor linkage assembly includes a first member pivotally connected to a pair of second members, the first member being pivotally connected to the chassis at the first pivot joint, the pair of second members being supported by the roller and track arrangement. In one embodiment, the roller and track arrangement includes a pair of tracks associated with the chassis and a pair of roller assemblies mounted to ends of the second members and received by the pair of tracks. In one embodiment, the pair of roller assemblies includes a pair of rollers and a spring biasing at least one of the rollers in a direction that is orthogonal to a length of the pair of tracks. In one embodiment, each of the pair of rollers defines a groove receiving one of the pair of tracks.

Another aspect of the present disclosure provides a compact utility vehicle, including a chassis extending along a longitudinal axis and carrying a prime mover and ground engaging wheels or tracks, a lift assembly supported by the chassis and being movable between a lowered position and a raised position via a first actuator, the lift assembly including a scissor linkage assembly supporting a frame, a hopper supported by the frame and being pivotable with respect to the frame between a dump position and a storage position via a second actuator, and a control arrangement configured to actuate the first and second actuators to selectively raise and lower the hopper and to pivot the hopper between the storage and dump positions based on a user input.

In one embodiment, the control arrangement is provided on a control console located at a rear end of the compact utility vehicle. In one embodiment, the control console can include a thumb switch control that defines a plurality of control surfaces for selectively actuating the first and second actuators. In one embodiment, the thumb switch control is mounted to a handle rigidly mounted to the control console.

In one embodiment, the compact utility vehicle further includes a first sensor for detecting a position of the hopper, the first sensor being in communication with the control arrangement. In one embodiment, the compact utility vehicle further includes a second sensor for detecting a position of the lift assembly, the second sensor being in communication with the control arrangement.

In one embodiment, the first and second actuators are hydraulic actuators that are actuated by electrically operated hydraulic control valves. In one embodiment, the prime mover is an electric motor. In one embodiment, the electric motor drives a hydraulic pump in fluid communication with the first and second actuators. In one embodiment, the ground engaging wheels or tracks are driven by one or more hydraulic motors in fluid communication with the hydraulic pump or by electric motors powered by a battery bank. In one embodiment, the ground engaging wheels or tracks are driven by one or more electric motors.

In one embodiment, a compact utility vehicle can include a chassis extending along a longitudinal axis and carrying a prime mover and ground engaging members, the chassis extending to a front end; a lift assembly supported by the chassis, the lift assembly including a frame, a linkage assembly, and a first actuator, wherein the frame is movable between a lowered position and a raised position via the linkage assembly and first actuator, the frame defining a front face that is rearward of the chassis front end in the lowered position and that is forward of the chassis front end in the raised position; and a hopper supported by the frame and being pivotable with respect to the frame about a pivot axis between a dump position and a storage position via a second actuator. In some examples, the pivot axis is forward of the chassis front end in both the lowered and raised positions of the frame. In some examples, a front edge of the hopper is forward of the chassis front end in both the lowered and raised positions of the frame.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a left profile view of a compact utility vehicle including a hopper positioned on a lift assembly, wherein the lift assembly is in a lowered position, and wherein the hopper is in a storage position in accordance with an embodiment of the disclosure.

FIG. 2 is the compact utility vehicle of FIG. 1, wherein the lift assembly is in the lowered position, and the hopper is in a dump position.

FIG. 3 is the compact vehicle of FIG. 1, wherein the lift assembly is in a raised position, and the hopper is in a storage position.

FIG. 4 is the compact vehicle of FIG. 1, wherein the lift assembly is in the raised position, and the hopper is in a dump position.

FIG. 5 is a left rear perspective view depicting a compact utility vehicle including a hopper positioned on a lift assembly, wherein the lift assembly is in a raised position, and the hopper is in a storage position in accordance with an embodiment of the disclosure.

FIG. 6 is a right front perspective view of the compact utility vehicle of FIG. 5.

FIG. 7 is a right profile view of the compact utility vehicle of FIG. 5.

FIG. 8 is a left profile view of the compact utility vehicle of FIG. 5.

FIG. 9 is a cross-sectional view of the compact utility vehicle of FIG. 5 cut along a plane parallel to the longitudinal and vertical axes.

FIG. 10 is a front view of the compact utility vehicle of FIG. 5.

FIG. 11 is a rear view of the compact utility vehicle of FIG. 5.

FIG. 12 is a right perspective view of a portion of a compact utility vehicle including a chassis, lift assembly, frame, and hopper, in accordance with an embodiment of the disclosure.

FIG. 13 is a left rear perspective view of the portion of the compact utility vehicle of FIG. 12.

FIG. 14 is a left profile view of the portion of the compact utility vehicle of FIG. 12.

FIG. 15 is a left profile view showing details of a sloped track of the frame of FIG. 12.

FIG. 16 is a left profile view showing details of a sloped track of the chassis of FIG. 12.

FIG. 17 is a perspective view depicting engagement of a pair of roller assemblies with a corresponding pair of sloped tracks of the frame of FIG. 12.

FIG. 18 is a perspective view depicting engagement of a pair of roller assemblies with a corresponding pair of sloped tracks of the chassis of FIG. 12.

FIG. 19 is a cross-sectional view depicting engagement of the pair of roller assemblies with the corresponding pair of sloped tracks of the frame of FIG. 17.

FIG. 20 is a cross-sectional view depicting engagement of the pair of roller assemblies with the corresponding pair of sloped tracks of the chassis of FIG. 18.

FIG. 21 is an exploded view of a first roller of a roller assembly, in accordance with an embodiment of the disclosure.

FIG. 22 is an exploded view of a second roller of a roller assembly, in accordance with an embodiment of the disclosure.

FIG. 23 is a cross-sectional view of the first roller of FIG. 21.

FIG. 24 is a cross-sectional view of the second roller of FIG. 22.

FIG. 25 is a schematic view depicting a control arrangement for operation of the compact utility vehicle, in accordance with an embodiment of the disclosure.

FIG. 26 is a left profile view of an alternative frame and hopper assembly usable with the compact utility vehicle shown in FIG. 1.

FIG. 27 is a perspective view of a portion of the frame and hopper assembly shown in FIG. 26, wherein a first frame stop arrangement is illustrated.

FIG. 28 is a perspective view of a portion of the frame and hopper assembly shown in FIG. 26, wherein a second frame stop arrangement is illustrated.

FIG. 29 is a cross-sectional perspective view of a portion of the frame and hopper assembly shown in FIG. 26, wherein a pivot joint arrangement connecting the hopper to the frame is illustrated.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

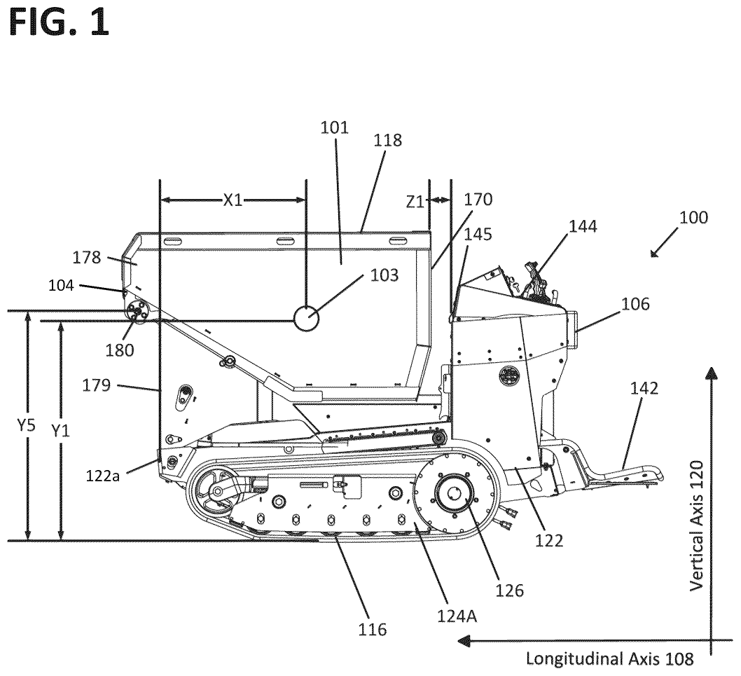

Referring to FIGS. 1-4, a compact utility vehicle 100 is depicted in accordance with an embodiment of the disclosure. As depicted, the compact utility vehicle 100 is in the form of a powered material transporting vehicle, including an implement 101 mounted to the compact utility vehicle 100. The compact utility vehicle 100 may alternatively be referred to as a light or compact vehicle loader, buggy, or any combination of these terms in various embodiments.

In the depicted example, the implement 101 is a hopper 102 or other container having an open top used for storing, transporting, and dispensing bulk materials. In other embodiments, the implement 101 can be at least one of a loader bucket, adjustable fork, grapple, auger, trencher, utility blade, or the like.

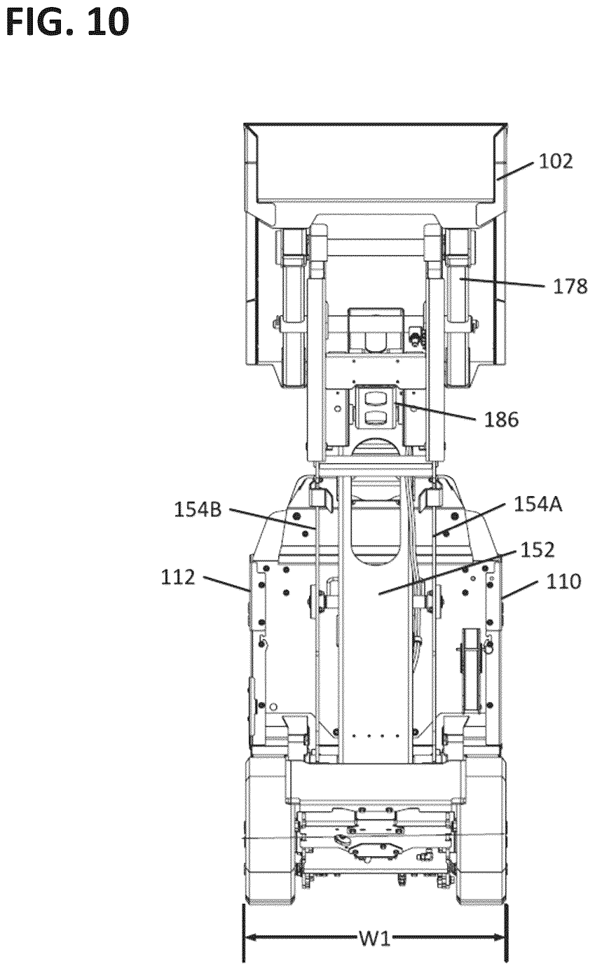

The compact utility vehicle 100 can have a length L1 extending between a front end 104 and a rear end 106 along a longitudinal axis 108 of the compact utility vehicle 100, a width W1 extending between a first side 110 (e.g., right side) and a second side 112 (e.g., left side) along a lateral axis 114 of the compact utility vehicle 100, and a height extending between a bottom 116 and a top 118 along a vertical axis 120 of the compact utility vehicle 100. In some embodiments, W1 can be less than about 36 inches, such that the compact utility vehicle 100 can fit through a standard/nominal 36 inch foot doorway opening. For example, in the embodiment shown in FIG. 10, W1 measures about 32 inches.

As used herein, positioning and orientational terms such as up, down, upper, lower, above, below, front, back, rear, forward, backward, rearward, horizontal, vertical, and so forth, may be used to refer to relative positioning of components in the compact utility vehicle 100 or portions of a component relative to each other when positioned in the compact utility vehicle 100. Such terminology is provided as a descriptive aid and does not limit how components or portions of components may be positioned or oriented in practice.

In embodiments, the compact utility vehicle 100 can include a chassis 122, which can be supported and moved across the ground surface by one or more ground engaging members such as wheels or tracks 124A, 124B. The one or more wheels or tracks 124A, 124B can be powered by a prime mover 126. The prime mover 126 can be an electric motor 132 that drives a hydraulic pump. In other embodiments, the prime mover 126 can include an internal combustion engine and a fuel tank, an electric motor including a battery power supply 130, or a hybrid system comprising a combination of such components.

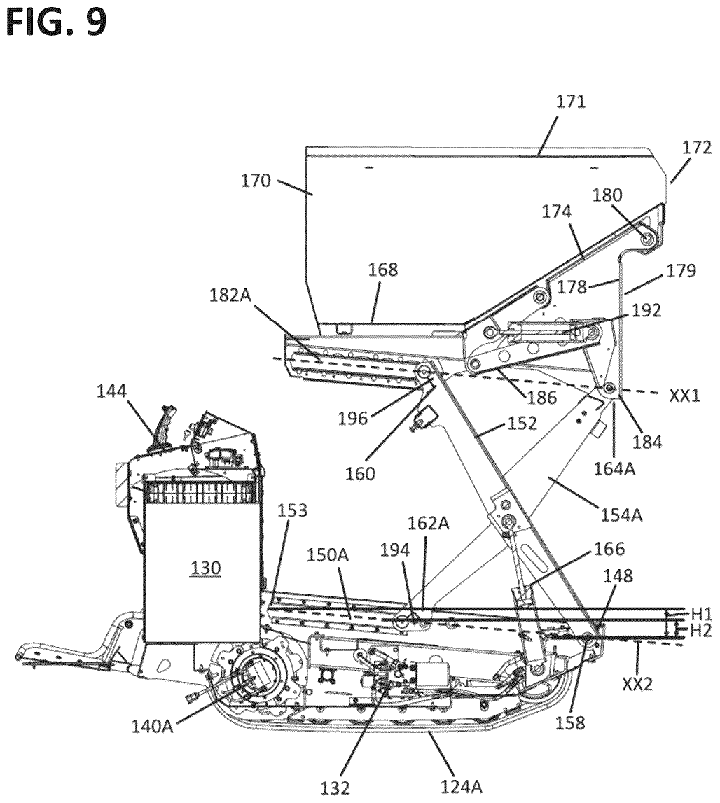

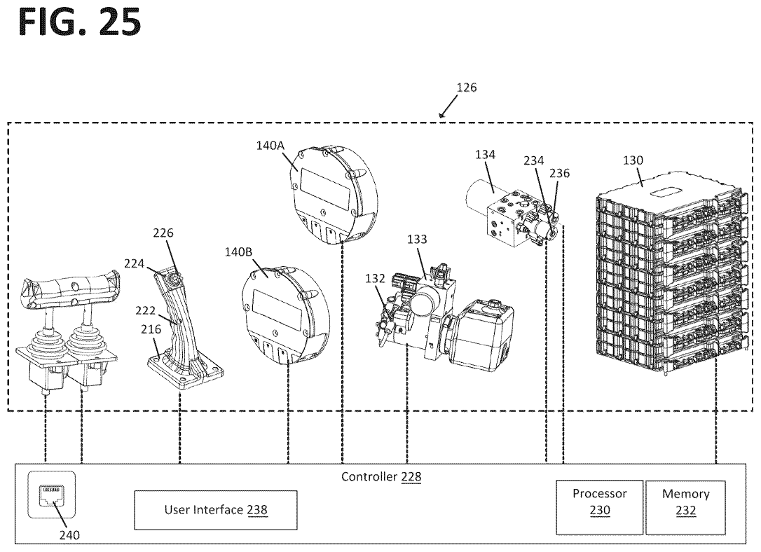

For example, as depicted in FIG. 25, in one embodiment, the prime mover 126 includes a plurality of electric motors 132, 140A, and 140B powered by the battery power supply 130. As illustrated, the electric motor 132 that provides power to a hydraulic system including one or more hydraulic pumps 133 driven by the electric motor 132, a control valve 134, one or more actuators 166, 192 (depicted in FIG. 9). The electric motors 140A, 140B are configured to respectively apply power to the one or more wheels or tracks 124A, 124B. An example hydraulic system and related control arrangement can be found in U.S. Pat. No. 9,970,176, assigned to the Toro Company of Bloomington, Minnesota. In some examples, the prime mover 126 can be configured with a single electric motor that powers a hydraulic pump which in turn supplies fluid power to both the actuators 166, 192 and the one or more wheels or tracks 124A, 124B. In some examples, the prime mover 126 can be configured as an internal combustion engine powering a hydraulic pump which in turn provides fluid power to the actuators 166, 192 and to hydraulic motors associated with the wheels or tracks 124A, 124B. In some examples, the prime mover 126 can be configured as an internal combustion engine which drives and electric motor-generator to charge the battery power supply 130, wherein the battery power supply 130 provides electrical power to electric actuators 166, 192 and to the wheels or tracks 124A, 124B.

The chassis 122 can serve as a rigid frame and foundational structure for the compact utility vehicle 100. The chassis 122 can provide a base to which other components, such as the wheels or tracks 124A, 124B and the prime mover 126 components, can be securely attached. In some embodiments, the chassis 122 can be constructed of a rigid metal, providing durability and stability to the compact utility vehicle 100.

During operation, the compact utility vehicle 100 can be maneuvered by an operator standing on a rear platform 142, which can allow the operator to actively control the compact utility vehicle 100. The controls necessary for maneuvering the compact utility vehicle 100 can be mounted on a control console 144, which can be operably connected to the chassis 122. For improved storage, in some embodiments, the rear platform 142 can be pivotably attached to the chassis 122 using hinges or other pivoting mechanisms. In other embodiments, the compact utility vehicle 100 can be at least partially autonomous or remotely controlled.

The chassis 122 can also serve as a mounting point for the implement 101 (e.g., hopper 102), facilitating manipulation of the implement 101 across a range of motions. For example, in one embodiment, the chassis 122 is designed to accommodate a lift assembly 146, to which the implement 101 can be operably coupled. In such an embodiment, the chassis 122 can define one or more first pivot joints 148 and one or more tracks 150A, 150B. In some embodiments, the tracks 150A and 150B can have a length of between about 24 inches and about 48 inches.

In one embodiment, lift assembly 146 can be configured as a scissor linkage, comprising a first member 152 and a second member 154 connected at a pivotal connection point 156. In embodiments, the first member 152 can be a single, unitary structure having a first end 158 and a second end 160. The first end 158 can be pivotably connected to the first pivot joint 148 on the chassis 122. The second end 160 can be operably linked to the implement 101, or a frame, to facilitate movement of the implement 101.

In embodiments, the second member can be comprised of two second members 154A and 154B, which can be pivotably coupled to the first member 152 at the pivotal connection point 156. Each of the second members can include a first end 162A, 162B and a second end 164A, 164B. The first ends 162A, 162B can be slidably coupled to the tracks 150A, 150B defined by the chassis 122, and the second ends 164A, 164B can be operably connected to the implement 101, or a frame, to facilitate movement of the implement 101.

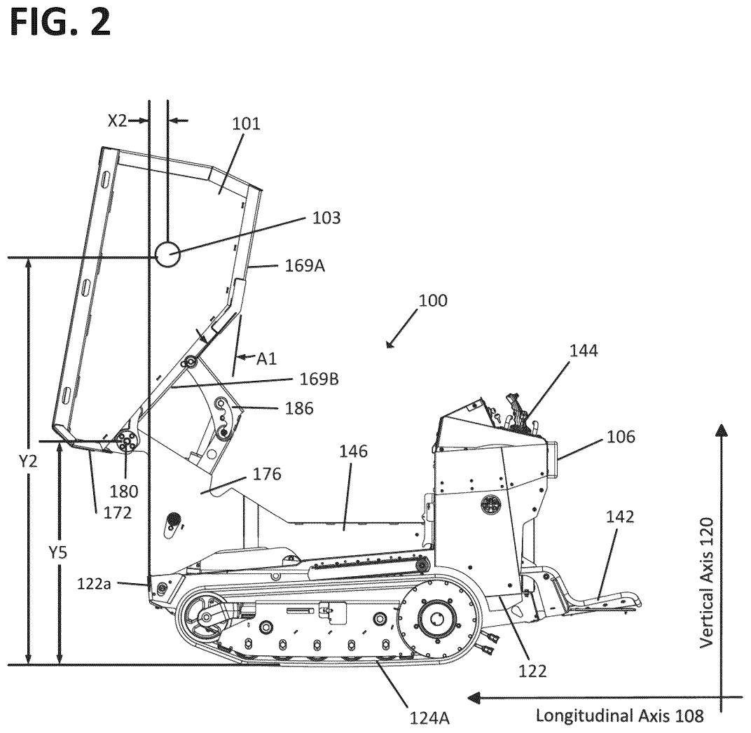

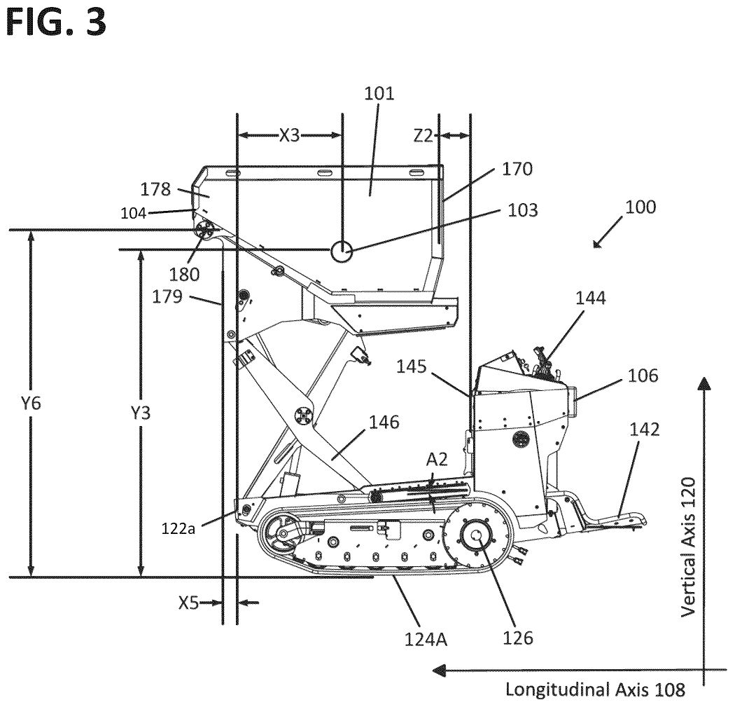

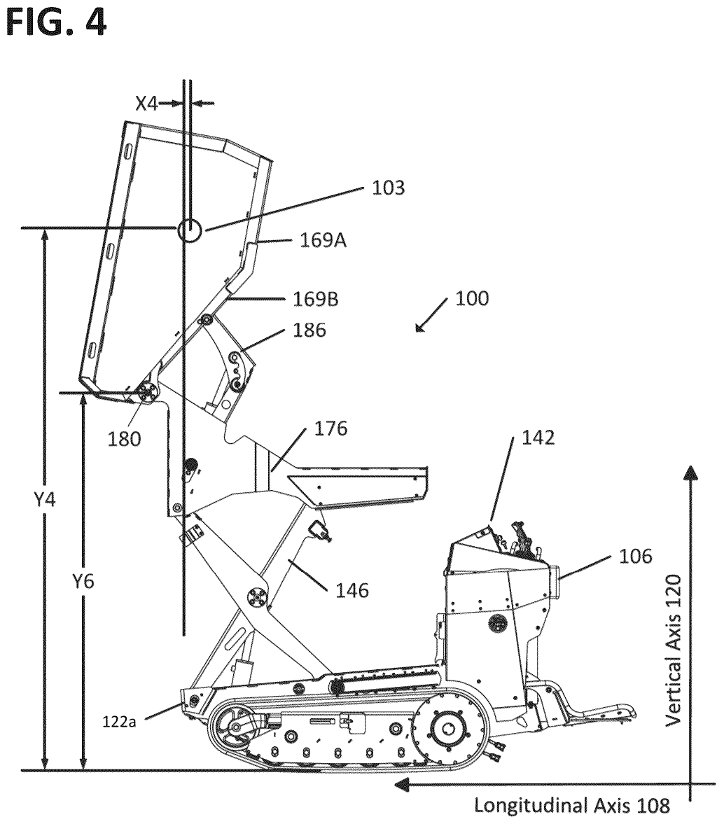

In embodiments, the lift assembly 146 can be characterized by its crisscrossing members 152, 154, connected at a pivotal connection point 156, that move relative to one another. The lift assembly 146 can expand and collapse, thereby enabling the scissor linkage to transition between different positions. In embodiments, the lift assembly 146 can be capable of transitioning between a lowered position (as depicted in FIGS. 1-2) and a raised position (as depicted in FIGS. 3-4).

Structural features of the lift assembly 146 can be configured to generally shift a center of mass 103 of the hopper 102 forward as the hopper 102 transitions from the lowered position to the raised position, which can be helpful in ensuring that the contents of the hopper 102 clear the dumpster wall in the raised position. Accordingly, structural features of the lift assembly 146 can enable the center of mass 103 of the hopper 102 to be lifted vertically upwards as well as laterally outward (e.g., forward), such that the lift provided by the lift assembly 146 has both a vertical component and a horizontal component.

Various configurations of the lift assembly 146 are contemplated to provide a lateral component to the lift. For example, as depicted in FIG. 9, in some embodiments, tracks 150A and 150B can extend along a linear track axis XX2, with the first pivot joints 148 generally positioned in-line along the linear track axis XX2. For example, in one embodiment, a first end 153 of the track 150A can be positioned a distance H1 that is vertically higher than the first pivot joint 148, and a second end 155 of the track 150A can be positioned a distance H2 that is vertically higher than the first pivot joint 148, with the first end 153 of the track 150A, the second end 155 of the track 150A, and the first pivot joint 148 being colinear. As further depicted in FIG. 16, in such an embodiment, the linear track axis XX2 can be generally sloped relative to the longitudinal axis 108 of the compact utility of vehicle 100, for example, sloping downwardly along the vertical axis 120 as the tracks 150A and 150B progress from the rear end 106 towards the front end 104 of the compact utility vehicle 100. For example, as depicted in FIG. 3, in one embodiment, the tracks 150A and 150B can generally be sloped at an angle A2, which can measure between about 1° and about 10°, resulting in a general forward movement of the implement 101 as the lift assembly 146 transitions from a lowered position to a raised position.

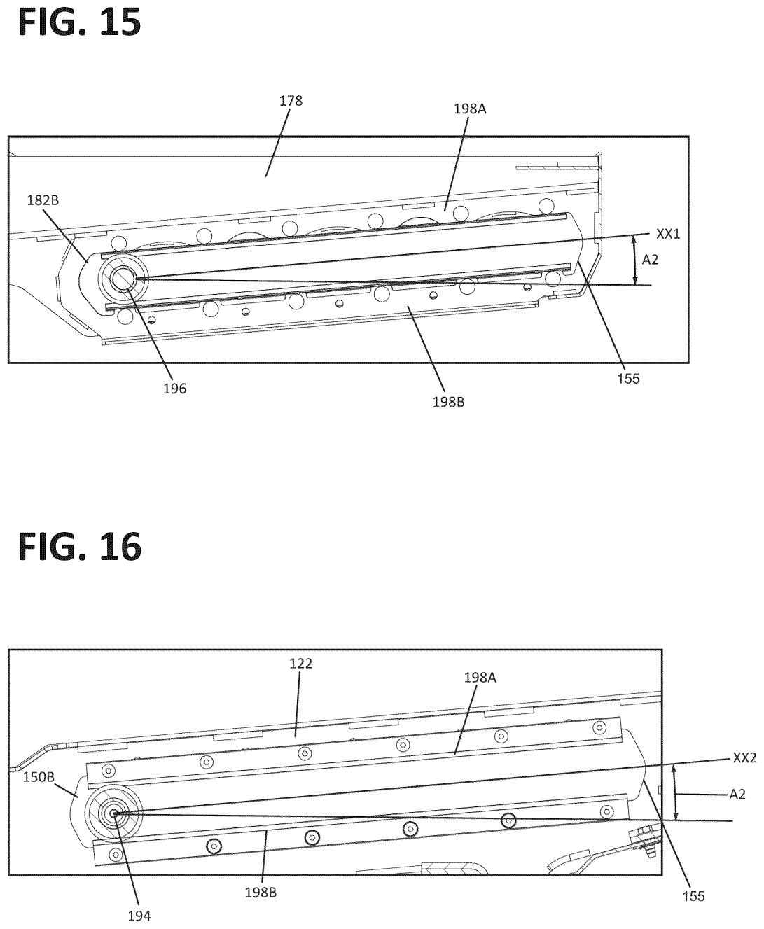

In one embodiment, tracks 150A and 150B have a length of about 36 inches, with a forward sloping angle A2 of about 5° providing between about 3-3.5 inches of forward travel of the implement 101 as the implement 101 transitions from a lowered position to a raised position. Accordingly, in embodiments, the forward movement of the center of mass 103 can be attributed to the forward ends of members 154, 156 being pinned, while their rearward opposite ends are slidable within the one or more tracks 182A, 182B (see FIGS. 9 and 15) that are sloped relative to horizontal such that the tracks 182A, 182B are also disposed at the angle A2 and are parallel to the tracks 150A, 150B.

As depicted in FIG. 1, in the lowered position (with the hopper 102 in the storage position), the center of mass 103 of the hopper 102 can be positioned at a distance X1 aft of the front end 122a of the chassis 122, and a distance Y1 above the bottom 116 of the compact utility vehicle 100. As depicted in FIG. 3, in the raised position (with the hopper 102 still in the storage position), the center of mass 103 of the hopper 102 can be positioned at a distance X3 aft of the front end 104 of the chassis, and a distance Y3 above the bottom 116 of the compact utility vehicle 100. Accordingly, transitioning the lift assembly 146 from the lowered position to the raised position can cause the center of mass 103 of the hopper 102 to be raised or lifted along the vertical axis a distance equal to the difference between Y3 and Y1, and shifted forward along the longitudinal axis a distance equal to the difference between X1 and X3. In some embodiments, the difference between Y3 and Y1 can be at least 24 inches, and the distance between X1 and X3 can be at least 1 inch. The compact utility vehicle 100 depicted in FIGS. 1-4 represents one example embodiment and should not be considered limiting with respect to specific angles, dimensions distances of travel.

Other configurations of the lift assembly 146 capable of producing a lateral lift component, include an arrangement in which a first end 153 of the track 150A, a second end 155 of the track and the first pivot joint 148 are not co-linearly arranged. For example, in one embodiment, the first pivot joint 148 can be offset from the linear track axis XX1 (e.g., first pivot joint 148 can be positioned either vertically higher or lower than the linear track axis XX1) which can result in articulation of the implement or hopper 102, which in turn produces a lateral lift component when transitioning from the lowered position to the raised position. For example, positioning the first pivot joints 148 vertically below the linear track axis XX1, with the tracks 150A, 105B positioned closer to the rear end 106 of the compact utility vehicle 100 results in a forward lift component. In other embodiments, a similar effect can be produced by the use of a nonlinear or curved track 150A, provided that the first end 153 of the track 150A and/or the second end 155 of the track are vertically higher than the first pivot joint 148.

In some embodiments, the lift provided by the lift assembly 146 enables the implement 101 to remain in a substantial fixed orientation (e.g., level with respect to a gravitational frame of reference) when transitioning from the lowered position to the raised position and vice versa. Alternatively, in some embodiments, the lift assembly 146 can be configured to establish either a front facing or rear facing articulation, tilt or rotation of the implement 101, as the lift assembly 146 transitions from the lowered position to the raised position.

Movement of the first member 152 relative to the second member 154, which enables the lift assembly 146 to transition between the lowered and raised positions, can be facilitated by an actuator 166. In one embodiment, the actuator 166 can be a linear hydraulic actuator, although the use of other types of actuators or driving mechanisms is also contemplated. The actuator 166 can be connected at one end to the chassis 122 and at the other end to the first member 152 of the lift assembly 146 to enable extension and retraction of the lift assembly 146.

As depicted, in some embodiments, the implement 101 can be in the form of a bucket (alternatively referred to herein as a tub or hopper 102), mounted near a front of the compact utility vehicle 100. In embodiments, the hopper 102 can be made of a single piece plastic or constructed using steel or other metallic elements, which can be useful in carrying building materials, such as sand, soil and cement among other things. For example, in some embodiments, the hopper 102 can be defined by a bottom 168, a side wall 170, and an open top 171 which can allow for ease in depositing, removal, storage and transportation of a variety of materials.

In some embodiments, the bottom 168 of the hopper 102 can include a flat portion 169A, which can be substantially horizontally oriented with respect to a gravitational frame of reference when the hopper 102 is in the storage position, and a sloped portion 169B, which can be angled relative to the flat portion 169A. For example, as depicted in FIG. 2, the sloped portion 169B can be angled relative to the flat portion 169B by angle A1, which can measure between about 10° and about 45°, for example about 30°. As further seen in FIGS. 2 and 4, when the hopper 102 is transitioned to the dump position, the flat portion 169A can be transitioned to be within about 15° of a vertical orientation with respect to the gravitational frame of reference, with the sloped portion 169B urging contents within the hopper 102 towards the front edge 172 of the hopper 102. Other configurations are possible. For example, the hopper 102 can be configured such that the flat portion 169A is placed in an entirely vertical position, or beyond, when in the dump position.

In one embodiment, the hopper 102 can define a front edge 172 and a sloped bottom surface 174, which among other things can facilitate easier loading of materials into the hopper and more efficient emptying when the hopper is tipped. In embodiments, the sloped bottom surface 174 can ensure that contents are directed towards the front edge 172 of the hopper 102, optimizing the dumping or unloading process.

In some embodiments, the hopper 102 can be operably coupled to a frame 178. The frame 178 can provide one or more connection points for attaching the hopper 102 to the lift assembly 146, thereby enhancing the structural integration and functionality of the hopper 102 within the compact utility vehicle 100. For example, in one embodiment, the hopper 102 can be connected to the frame 178 about a pivot joint 180, enabling the hopper 102 to transition from the storage position to the dump position by pivoting around pivot joint 180. Due to the high location of the pivot joint 180, the hopper 102 has an increasing the clearance height when the hopper 102 is transition to the dump position. In some examples, the pivot joint 180 can be characterized as being vertically higher than the center of gravity of the hopper. In some examples, the pivot joint 180 can be characterized as being above a centerline of the hopper 102 such that the pivot joint 180 is more proximate the top wall 171 of the hopper 102 in comparison to the bottom wall 168.

The frame 178 can also serve as a connection point for the lift assembly 146. For example, in one embodiment, the frame 178 can define one or more tracks 182A, 182B and one or more second pivot joints 184. In some embodiments, the second end 160 of the first member 152 of the lift assembly can be positioned within the tracks 182A, 182B, while the second ends 164A, 164B of the second members 154A, 154B can be positioned within the second pivot joints 184 to ensure stability and controlled movement of the hopper 102 during operation.

In some embodiments, the frame 178 has a front face 179 that is positioned forward of the front end 104 of the chassis 122 when the lift assembly 146 is in the raised position, and situated rearward of the front end 104 of the chassis 122 when the lift assembly 146 is in the lowered position. In embodiments, the forward displacement of the front face 179 of the frame 178 relative to the front end 104 of the chassis 122 (when in the raised position) can be equal to the difference between X1 and X3 (labeled as X5 in FIG. 3). In embodiments, X5 can measure between about 1 inch and about 6 inches. In one embodiment, X5 measures between about 3 inches and about 3.5 inches.

The tracks 182A, 182B on the frame 178 can be designed to slope downwardly towards the front end of the compact utility vehicle 100, similar to the angle of tracks 150A, 150B. The track design enables the hopper 102 to shift forward along the longitudinal axis 108 as the lift assembly 146 transitions from the lowered to the raised position, providing additional forward movement of the hopper 102 for dumping (e.g., to assist in clearing a fender of a dumpster).

In embodiments, the hopper 102 can be designed to move both forward along the longitudinal axis 108 and upward along the vertical axis 120, corresponding with the lift assembly 146 transitioning between its lowered and raised positions. In some embodiments, a sloped orientation of the tracks 150A, 150B, 182A, 182B can serve to provide this advantage. With the sloped orientation of the tracks 150A, 150B, 182A, 182B, as the hopper 102 elevates, there is a forward shift in support of the center of mass 103. In other embodiments, the tracks 150A, 150B, 182A, 182B may have a non-linear structure or the first or second pivot joints 148, 184 may be offset from their respective linear track axis XX2, XX1. This shift in the center of mass 103 can be particularly beneficial when the hopper 102 transitions from the storage position to the dump position, as the transition can have the effect of shifting the weight of the hopper 102 (and its contents) above and as close as possible to the edge (and in some cases over the edge) of the dumpster.

In embodiments, the hopper 102 can transition between a storage position, where it is maintained in a substantially horizontal orientation relative to the longitudinal axis 108 of the compact utility vehicle 100 (as depicted in FIGS. 1 & 3), and a dump position, where it is tilted relative to the longitudinal axis 108 (as depicted in FIGS. 2 & 4).

To enable the transition of the hopper 102 from the storage to the dump position, in some embodiments, the vehicle can include a dump assembly 186. The dump assembly 186 can be configured to pivot the hopper 102 relative to the frame 178 about pivot joint 180. The dump assembly 186 can be in the form of a two-bar linkage including a first member 188 and a second member 190. The first member 188 can be pivotably coupled between the frame 178 and the second member 190, while the second member 190 can be pivotably coupled between the first member 188 and the hopper 102.

In some embodiments, the dump assembly 186 can include an actuator 192 to facilitate movement between a contracted position (where the hopper 102 is in the storage position) and an extended position (where the hopper 102 is in the dump position). The actuator 192, which may be a linear hydraulic actuator or other types of actuation mechanisms, can be pivotably connected at one end to the dump assembly 186 (e.g., second member 190) and at the other end to the frame 178. Extension and contraction of the actuator 192 can control the transition of the hopper 102 between the storage and dump positions.

Structural features of the dump assembly 186 can be configured to generally shift a center of mass 103 of the hopper 102 forward as the hopper 102 is transitioned from the storage position to the dump position. In particular as depicted in FIG. 1, in the storage position (with the lift assembly 146 in the lowered position) a center of mass 103 of the hopper 102 can be positioned at a distance X1 aft of the front end 104 of the chassis 122, and a distance Y1 above a bottom 116 of the compact utility vehicle 100.

As depicted in FIG. 2, in the dump position (with the lift assembly 146 still in the lowered position) a center of mass 103 of the hopper 102 can be positioned at a distance X2 aft of the front end 104 of the chassis 122 and a distance Y2 above the bottom 116 of the compact utility vehicle 100. In this position, the pivot joint 180 of the hopper 102 can be positioned at a distance Y5 above the bottom 116 of the compact utility vehicle 100.

In some embodiments, transitioning the hopper 102 from the storage position to the dump position can cause the center of mass 103 of the hopper 102 to be raised or lifted along the vertical axis a distance equal to the difference between Y2 and Y1, and shifted forward along the longitudinal axis the distance equal to the difference between X1 and X2. In some embodiments, the difference between Y2 and Y1 can be at least 24 inches, and the distance between X1 and X2 can be at least 1 inch. In some embodiments, the hopper 102 is rotated through about 80 degrees about the pivot axis 180 between the storage and dump positions.

As depicted in FIG. 3, in the storage position (with the lift assembly 146 in the raised position) the center of mass 103 at the hopper 102 can be positioned at a distance X3 aft of the front end 104 of the chassis, and a distance Y3 above the bottom 116 of the compact utility vehicle. In this position, the pivot joint 180 of the hopper 102 can be positioned a distance Y6 above the bottom 116 of the compact utility vehicle. In one embodiment, distance Y6 can measure about 80 inches in length.

As depicted in FIG. 4, in the dump position (with the lift assembly 146 still in the raised position), a center of mass 103 of the hopper 102 can be positioned a distance X4 aft of the front end 104 of the chassis 122 and a distance Y4 above the bottom 116 of the compact utility vehicle 100. Accordingly, in some embodiments, transitioning the hopper 102 from the storage position to the dump position can cause the center of mass 103 of the hopper 102 to be raised or lifted along the vertical axis a distance equal to the difference between Y4 and Y3, and shifted forward along the longitudinal axis the distance equal to the difference between X3 and X4. In some embodiments, the difference between Y4 and Y3 can be at least 24 inches, and the distance between X3 and X4 can be at least 1 inch.

With reference to FIGS. 15-16, the tracks 182A, 182B on the frame 178 and the tracks 150A, 150B on the chassis 122 can be designed as slots or channels to accommodate roller assemblies. For example, the tracks 150A, 150B on the chassis 122 can be configured to receive a first roller assembly 194, which pivotably and slidably couples the first ends 162A, 162B of the second members 154A, 154B to the chassis 122. Similarly, the tracks 182A, 182B on the frame 178 can be designed to receive a second roller assembly 196, enabling the pivotable and slidable coupling of the second end 160 of the first member 152 to the frame 178.

The tracks 182A, 182B, 150A, 150B can feature a slot length that allows the first and second roller assemblies 194, 196 to slide or transition along these tracks. Additionally, as one possible mechanism for establishing a lateral lift component, the tracks 182A, 182B, 150A, 150B can be sloped relative to the longitudinal axis 108, generally sloping downwardly along the vertical axis towards the front end 104 of the vehicle. For example, in embodiments, the 182A, 182B, 150A, 150B can have a downward or forward angled slope A2 of between about 1 degree to about 10 degrees relative to the longitudinal axis 108, which can aid in the forward shift of the lift assembly 146 as it moves from the lowered to the raised position. With reference to FIG. 9, it can be seen that a linear axis XX1 passes through pivot joints 184, the center axis of the roller assembly 196, and through a centerline of the tracks 182A, 182B. Similarly, a linear axis XX2 passes through pivot joints 148, the center axis of the roller assembly 194, and through a centerline of the tracks 150A, 150B, wherein axes XX1 and XX2 are parallel to each other. With such a configuration, the orientation of the hopper 170 will remain unchanged as the lift assembly 146 raises and lowers the hopper 102 even though the hopper 102 is translating forward or rearward during operation of the lift assembly 146. Other configurations configured to provide a forward component of lift are also contemplated. For example, the pivot joints 148, 184 could lie outside of the axes XX1, XX2 such that an orientation of the hopper 102 could change during lifting and lowering operations. Such configurations are not mutually exclusive, and therefore may be combined to produce the desired forward lift component. Further, in the example shown, the scissor linkage assembly is configured such that the distance between the center axes of the first roller assembly 194 and the pivot joint 184 is equal to a distance between the center axes of the second roller assembly 196 and the pivot joint 148. Other configurations are possible. For example, the distance between the first roller assembly 194 and the pivot joint 184 can be greater than or less than a distance between the center axes of the second roller assembly 196 and the pivot joint 148.

In some embodiments, the tracks can include one or more rails 198 upon which a wheel or roller 202 can ride. To ensure a proper wheel-rail interface, in some embodiments, the wheel or roller 202 can include a circumferential groove 204, configured to engage with a portion of the rail 198, which can enhance the stability and smoothness of the rollers movement along the track.

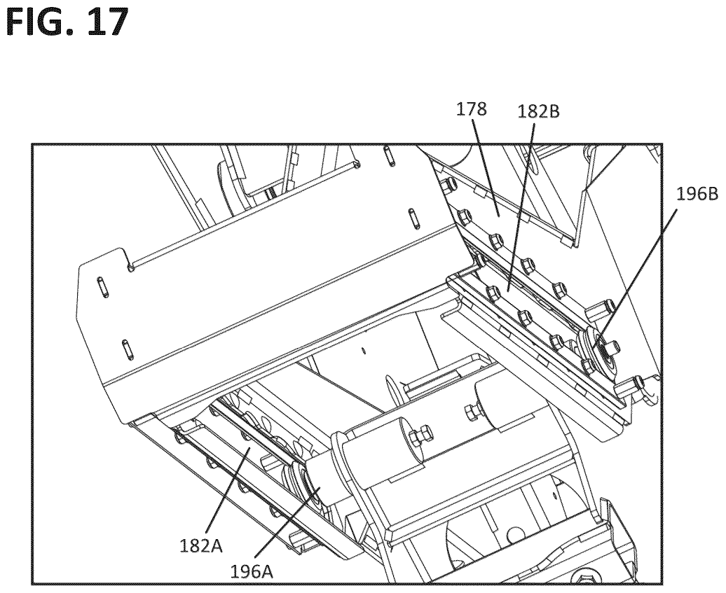

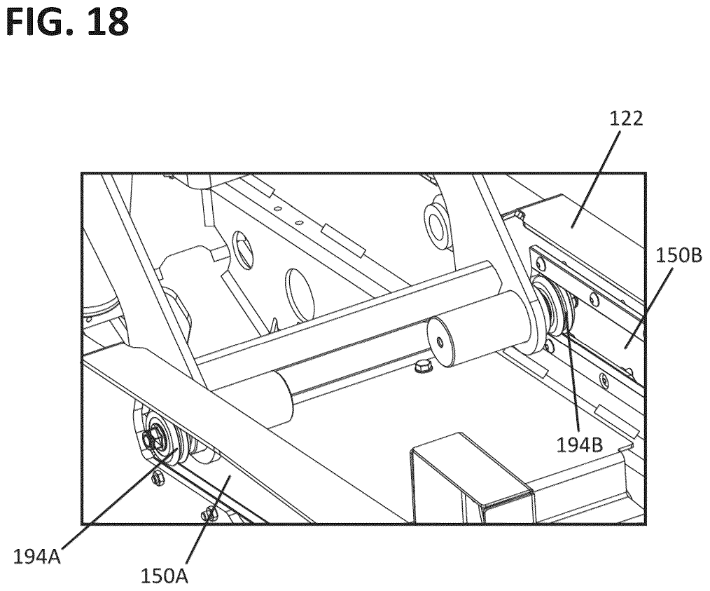

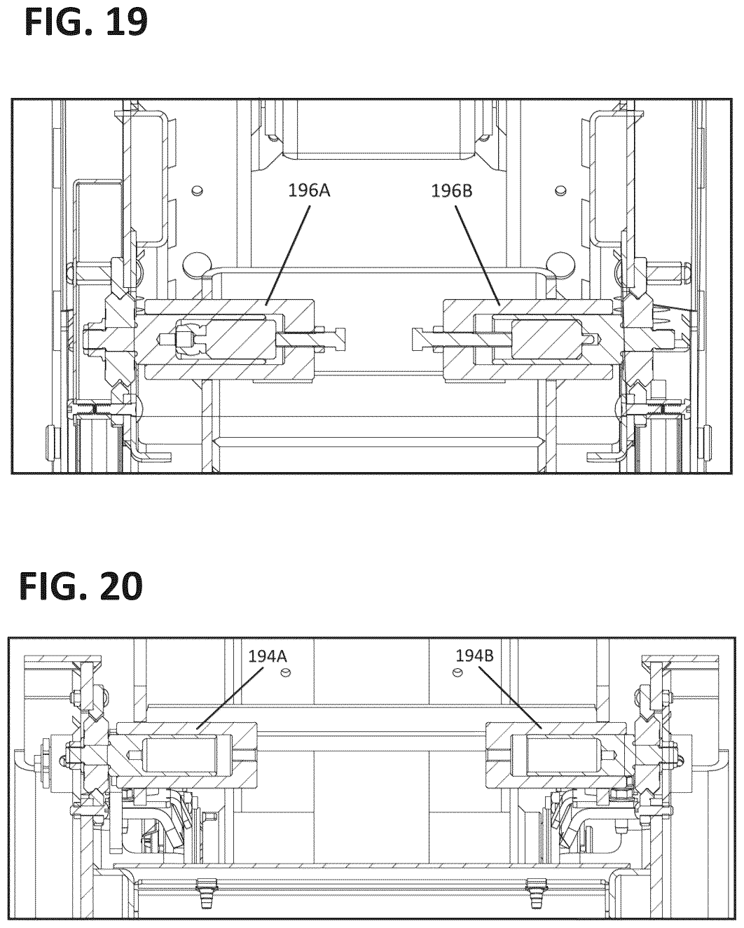

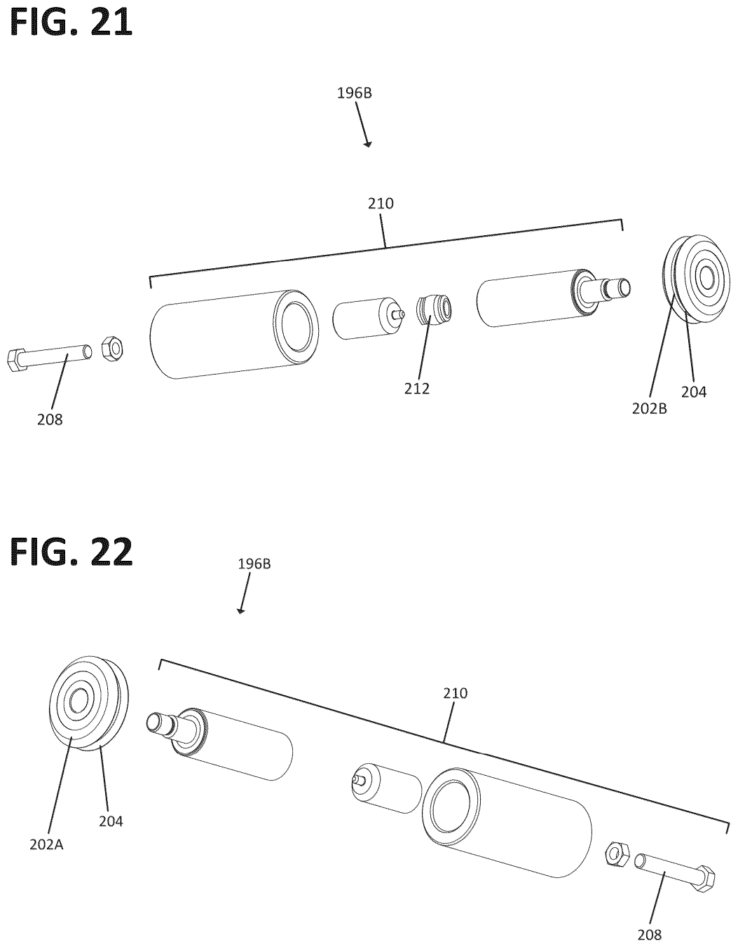

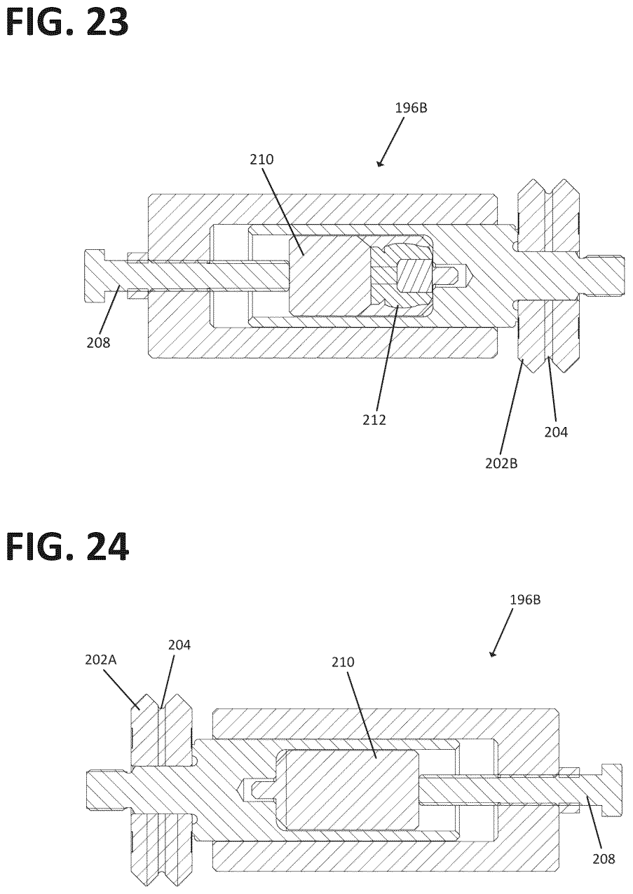

As detailed in FIGS. 19-24, each roller assembly 194A-B and 196A-B can include a pair of rollers 202, referenced as 202A, 202B. The rollers 202A, 202B can be operably connected to an axle or fastener 208, for example via a bushing or bearing assembly 210, to ensure smooth rotation and movement along the tracks. To account for manufacturing tolerances and ensure smooth operation, a resilient member 212, such as a resilient member or rubber spring, can be positioned in line with the fastener 208. The resilient member 212 can apply an axial tension between the rollers 202A, 202B to apply pressure against the rails 198 to provide consistent contact therebetween. In other words, the resilient member 212 may apply axial tension to overcome any manufacturing tolerances between the rollers 202 and the rails 198 (e.g., to increase lateral stability and remove looseness between the rollers 202 and the rails 198). Also, the resilient member 212 can be configured to enable at least one of the rollers 202A, 202B the freedom to move along the lateral axis to accommodate small variations in distance as the rollers 202A, 202B travel along the tracks 182A, 182B, 150A, 150B.

In some embodiments, a forward shift of the hopper 102, as the lift assembly transitions from the lowered position to the raised position, can serve to provide additional clearance between a side wall 170 of the hopper 102 and a forward facing surface or hopper facing edge 145 of the control console 144, thereby reducing the likelihood of the user interaction between the side wall 170 of the hopper 102 and the hopper facing edge 145 of the of the control console 144. As depicted in FIG. 1 with the lift assembly 146 in the lowered position, a distance between side wall 170 of the hopper 102 and a forward facing surface or hopper facing edge 145 can be measured as Z1. As depicted in FIG. 3, with the lift assembly 146 in the raised position, a distance between side wall 170 of the hopper 102 and a forward facing surface or hopper facing edge 145 can be measured as Z2.

Accordingly, transitioning the lift assembly 146 from the lowered position to the raised position can cause the distance between side wall 170 of the hopper 102 and a forward facing surface or hopper facing edge 145 to be extended the longitudinal axis a distance equal to the difference Z2 and Z1. In some embodiments, the distance between Z2 and ZIcan be at least 1 inch.

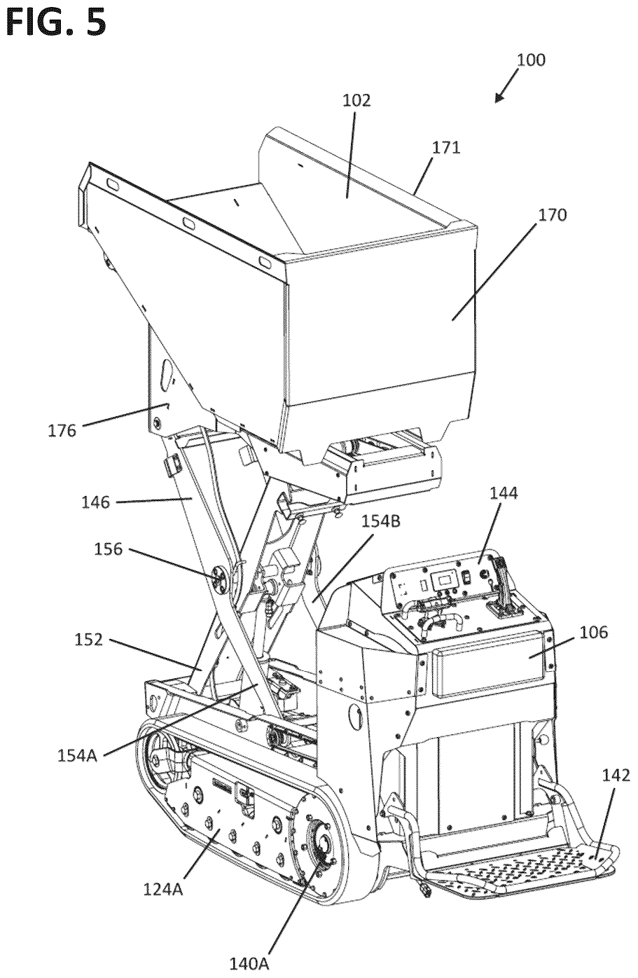

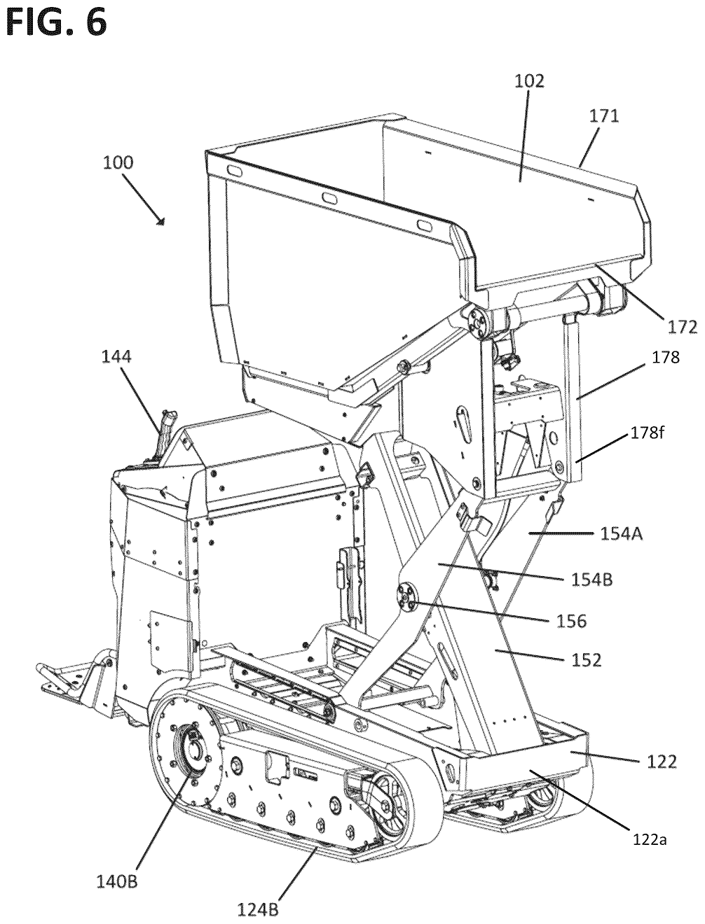

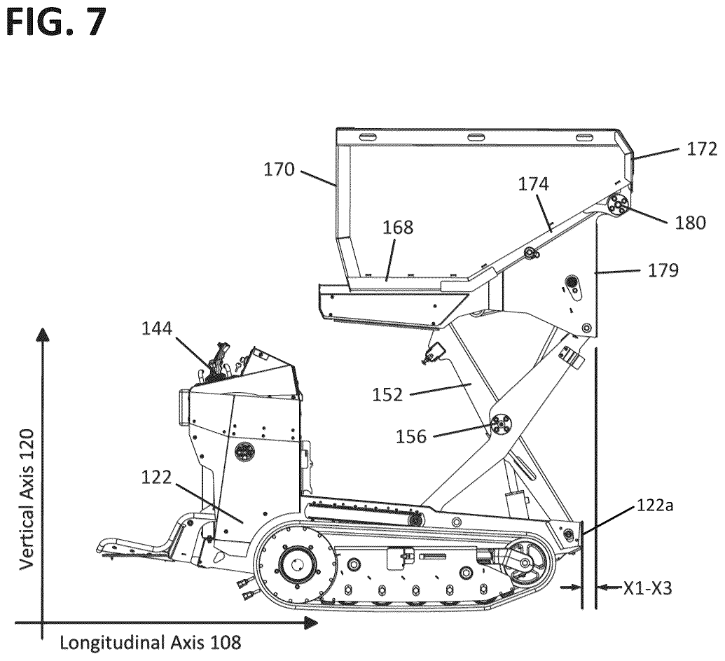

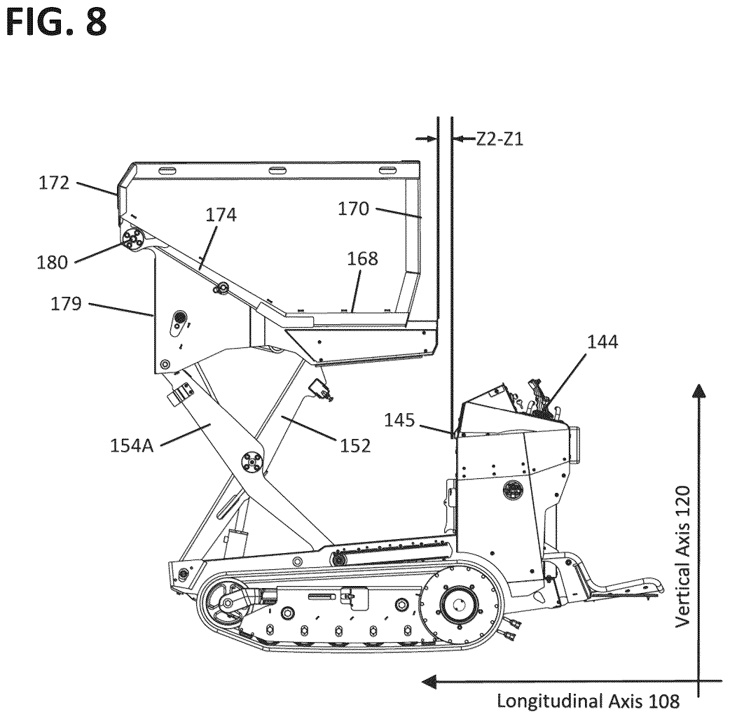

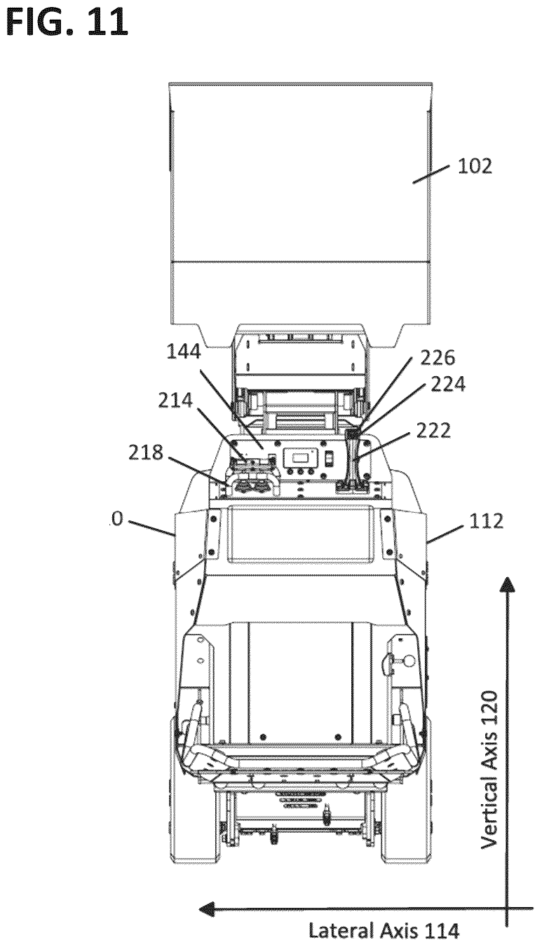

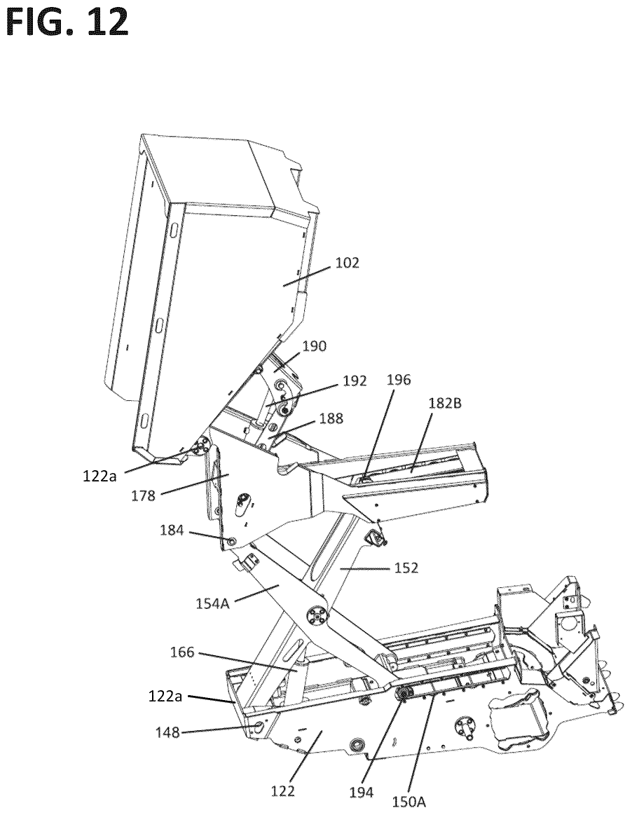

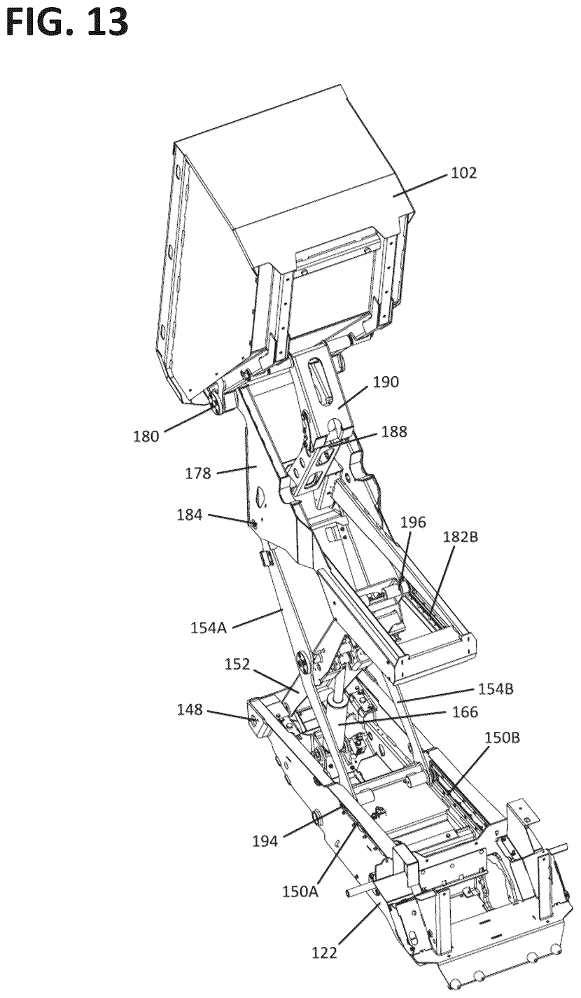

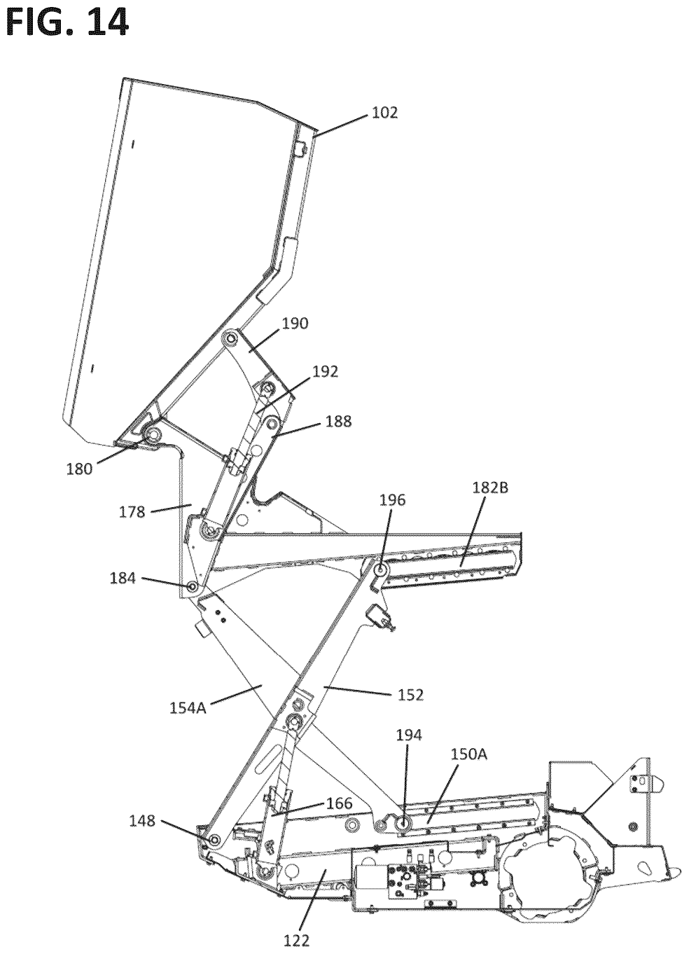

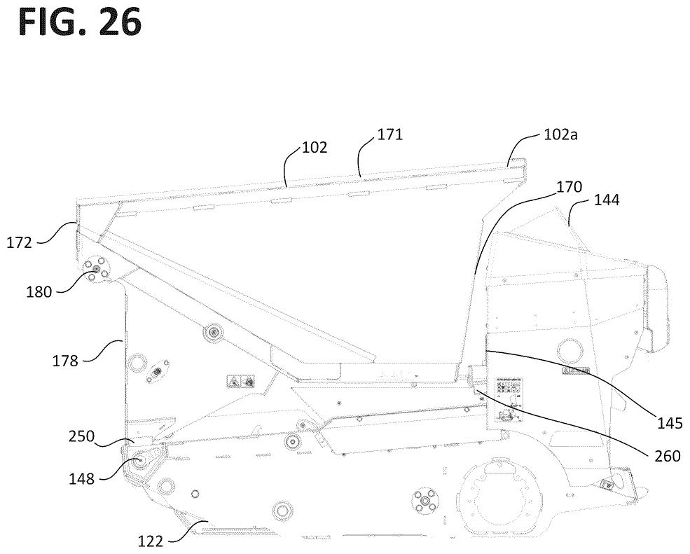

With reference to FIGS. 26 to 29, an alternative frame and hopper assembly is presented showing modified components that may be integrated into the example shown at FIGS. 1-24 in whole or in part. In one aspect, the hopper 102 shown in FIG. 26 is additionally provided with a rearward portion 102a that extends over the top of the control console 144. The bottom of the rearward portion 102a is provided with an upward trajectory generally matching that of the control console 144. With such an arrangement, the control console 144 may be at least partially protected from debris by the hopper 102 while the volume of the hopper 102 is also slightly increased. The hopper 102 shown in FIG. 26 is also shown as being provided with a straight front wall 172 forming a corner with the top wall 171, and is also shown as being provided with a straight sidewall 170 oriented at a slight oblique angle to the forward facing surface 145 of the control console 144.

With continued reference to FIG. 26, it can be seen that the assembly is further provided with a pair of front support arrangements 250 and a pair of rear support arrangements 260 for supporting the frame 178 relative to the chassis 122. While FIG. 26 shows support arrangements 250, 260 located on the left-hand side of the assembly, it should be understood that identical arrangements are also provided on the right-hand side of the assembly.

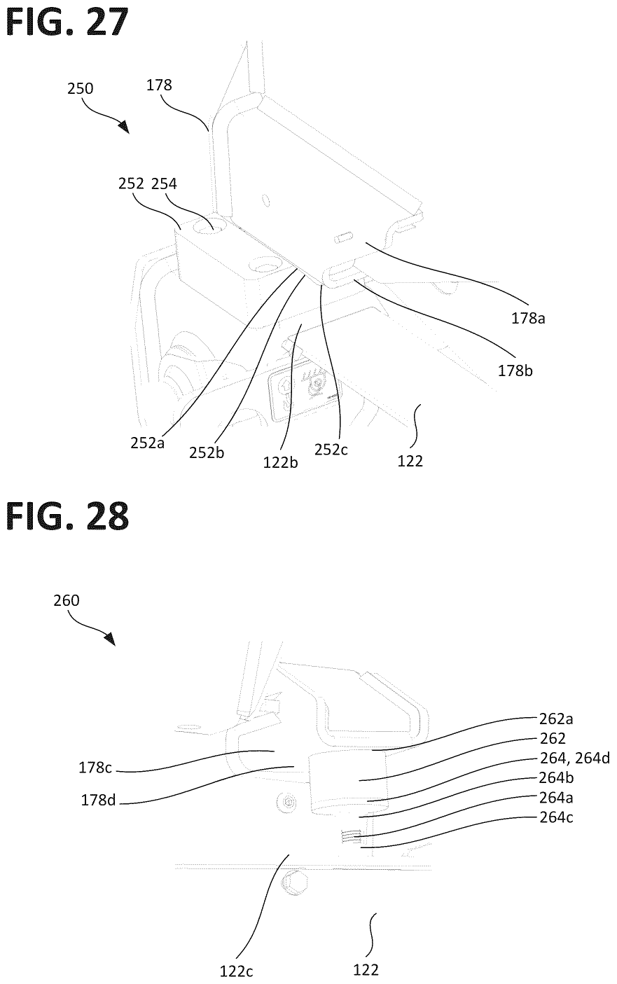

As illustrated at FIG. 27, each front support arrangement 250 is configured with an elastomeric support member or pad 252 mounted to an upward facing support surface 122b of the chassis 122. In the example shown, the support pad 252 is secured to the chassis 122 with a pair of fasteners, such as bolts or screws 254. Other attachment means are also possible. As shown, the frame 178 is provided with a pair of projections or weldments 178a presenting a downward-facing support surface 178b. In some examples, the surface 178b can be a bottom portion of the main part of the frame 178. As the frame 178 is lowered, the support surface 178a of the frame eventually comes into contact with an upward facing surface 252a of the support pad 252 such that the frame 178 is supported by the chassis 122 without metal-to-metal contact occurring. As shown, the upward facing surface 252a of the support pad 252 has a sloped portion 252b that aids in guiding the frame 178 and support surface 178a towards an inner portion 252c that supports the frame 178 in the lowered position.

As illustrated at FIG. 28, each rear support arrangement 260 is configured with an elastomeric support member or pad 262 mounted to an upward facing support surface 122c of the chassis 122. In the example shown, the support member or pad 262 is secured to the chassis 122 with a support assembly 264 formed from a threaded rod portion 264a, a pair of opposing nuts 264b, 264c, and a washer 264d. With such a construction, the height of the support surface 262a can be adjusted as required to contact the chassis 122 at the appropriate height. As shown, the frame 178 is provided with a pair of projections or weldments 178c presenting a downward-facing support surface 178d. In some examples, the surface 178c can be a bottom portion of the main part of the frame 178. As the frame 178 is lowered, the support surface 178c of the frame eventually comes into contact with an upward facing surface 262a of the support pad 262 such that the frame 178 is supported by the chassis 122 without metal-to-metal contact occurring. It is noted that the frame 178 may be alternatively supported with support arrangements 250 at the front and rear, with support arrangements 260 at the front and rear, or in the reverse configuration as shown with the support arrangements 250 at the rear and the support arrangements 260 at the front.

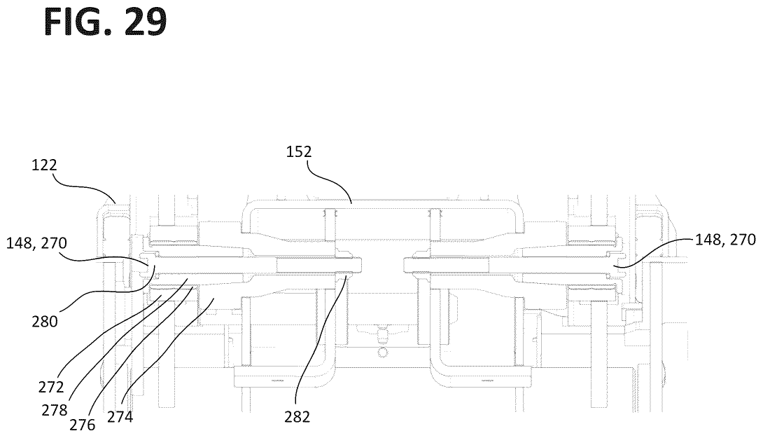

With reference to FIG. 29, a pair of pivot joint assemblies 270 forming the pivot joints 148 is depicted in cross-section. In one aspect, the pivot joint assemblies 270 each include sleeve members 272, 274 that are respectively mounted to the chassis 122 and frame member 152, such as via welding or other means, for example, a press fit. The sleeve member 272 receives a bearing outer component 276 which in turn receives a bearing inner component 278 that is rotatable with respect to the outer component 276. As shown, the bearing inner component 274 has a tapered outer surface that is received by a correspondingly shaped tapered inner surface of the sleeve member 274. Further, the assembly is held together by an arrangement including a bolt or pin 280 and a fastener 282. Other fastening means are possible. With the disclosed arrangement, the pivot joint assemblies 270, and in particular, the tapered surfaces of the inner bearing component 278 and the sleeve member 274, a pivot joint is created that is relatively easy to assemble even in the case where the joined components 122, 152 are not initially closely aligned with each other. In such cases, the pivot joint assemblies 270 can be used to achieve the desired alignment during the assembly process. The disclosed pivot joint assemblies 270 may be used at other locations as well, such as for pivot joints 180 and 187.

### Vehicle Controls

With reference to FIG. 25, the compact utility vehicle 100 can include a controller 228. In one embodiment, the controller 228 includes a processor 230 and a non-transient storage medium or memory 232, such as RAM, a flash drive, or a hard drive. Memory 232 is for storing executable code, the operating parameters, and the input from a user interface 238, while processor 230 is for executing the code. Memory 232 can also be for storing reference information such as maps and/or lookup tables. The controller 228 is also shown as including a transmitting/receiving port 240, such as an Ethernet port for two-way communication with a WAN/LAN related to an automation system.

In some embodiments, the first manual input device 214 can be configured to control the ground engaging wheels or tracks 124A, 124B, while the second manual input device 216 can be configured to control operation of the implement 101. In some embodiments, the first manual input device 214 can be positioned on a left side of the compact utility vehicle 100 and the second manual input device 216 can be positioned on the right side of the compact utility vehicle 100. In other embodiments, the positions of the first and second manual input devices 214, 216 can be reversed.

For example, in some embodiments, the first manual input device 214 can be at least one of a dual joystick or dual lever control system arranged to independently control the forward and reverse direction for each ground engaging wheel or track 124A, 124B. As depicted, one or more grab bars 218 can be fixedly coupled to the control console 144. In one embodiment, the grab bars 218 can be provided in front of and in back of input device 214 and allow the user to rest portions of his or her hand or fingers on grab bars 218 when operating input device 214. An example arrangement including a first manual input device 214 and grab bars 218 can be found in U.S. Pat. No. 9,970,176, the entirety of which is incorporated herein by reference.

In some embodiments, the first manual input device 214 can include a plurality of switches configured to enable control over movement of the compact utility vehicle 100. In particular, manipulation of the switches can affect control of electrical motors 140A, 140B, or cause hydraulic fluid pressurized by a hydraulic pump 133 (powered by the battery power supply 130, configured as a battery bank) to flow to respective hydraulic motors 220A, 220B operably coupled to the wheels or tracks 124A, 124B. Accordingly, pressing the first manual input device 214 in a forward direction causes forward motion of the compact utility vehicle 100. Pulling back on the first manual input device 214 in a rearward direction causes rearward motion of the compact utility vehicle 100. Rotation of the first manual input device 214 in either a clockwise or counterclockwise direction causes turning of the vehicle 100.

In some embodiments, the second manual input device 216 can include a rigid grip 222, and a control head 224. The rigid grip 222 provides the user with a stability point during operation of the vehicle. The control head 224 of the second manual input device 216 can include a thumb switch 226, which can include a plurality of control surfaces associated with sensors to provide signals to control operation of the implement 101. For example, in one embodiment, the plurality of control surfaces can be defined by a thumb stick, alternatively referred to as a joystick or thumb pad which can be moved in different directions by a user's thumb, which in turn is translated into control signals for operation of the implement 101.

In some embodiments, the second manual input device 216 can include a first switch configured to return the hopper 102 to a return or home position, alternatively referred to as the lowered position, and a second switch configured to drive the hopper 102 to a raised position. In some embodiments, the second manual input device 216 can include a third switch configured to pivot the hopper 102 in a first direction (e.g., to a storage position), and a fourth switch configured to pivot the hopper 102 in a second direction (e.g., to the dump position), such that the third and fourth switches enable pivoting or dumping of the hopper 102.

In some embodiments, the second manual input device 216 can be biased in control of the implement 101, such that absent user input, one or more of the switches are activated, thereby moving the implement 101 to a particular position. For example, in some embodiments, removal of a user's hand from the second manual input device 216 can cause the implement 101 to return to the home position, in which the lift assembly is lowered and the hopper is moved to the storage position.

The user interface 238 may be provided, for example at a control panel to activate and deactivate the system, allow a user to manipulate certain settings or inputs to the controller 228, and to view information about the system operation. The controller 228 typically includes at least some form of memory 232. Examples of memory 232 include computer readable media. Computer readable media includes any available media that can be accessed by the processor 230. By way of example, computer readable media can include computer readable storage media and computer readable communication media. Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the processor 230. Computer readable communication media typically embodies computer readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

In some embodiments, the second manual input device 216 can be configured to control operation of the control valves 134, which can direct pressurized hydraulic fluid (e.g., pressurized via the hydraulic pump 133) to circulate relative to either of the lift assembly actuator 166 or the dump linkage actuator 192.

The controller 228 can be in communication with a first sensor 234 used for detecting a position of the hopper 102, and a second sensor 236 for detecting a position of the lift assembly 146. The user interface 238 can be configured to show a relative position of the hopper 102 and lift assembly 146, and in some embodiments, enabling user manipulation of the compact utility vehicle 100.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A compact utility vehicle, comprising:
a) a chassis extending along a longitudinal axis and carrying a prime mover and ground engaging members;
b) a lift assembly supported by the chassis and being movable between a lowered position and a raised position via a first actuator, the lift assembly including a scissor linkage assembly supported by the chassis via a track and a fixed first pivot joint, wherein the track extends between a first end and a second end, wherein the second end of the track is closer to the first pivot joint than the first end of the track is to the first pivot joint, wherein the second end of the track is positioned at a higher vertical location in comparison to the first pivot joint; and
c) a hopper supported by the lift assembly and being pivotable with respect to the lift assembly between a dump position and a storage position via a second actuator.

2. The compact utility vehicle of claim 1, wherein the track is sloped relative to horizontal with respect to a gravitational frame of reference to produce a lateral forward component of lift when being raised from the lowered position to the raised position.

3. The compact utility vehicle of claim 1, wherein the first end of the track and the second end of the track are positioned colinear with the fixed first pivot joint to maintain an orientation of the hopper between the lowered and raised positions.

4. The compact utility vehicle of claim 1, further comprising a control arrangement configured to actuate the first and second actuators to selectively raise and lower the lift assembly between the lowered and raised positions, and to pivot the hopper between the storage and dump positions based on a user input.

5. The compact utility vehicle of claim 1, wherein the scissor linkage assembly includes a first member pivotally connected to a second member, the first member being pivotally connected to the chassis at the first pivot joint, the second member being supported by the track.

6. The compact utility vehicle of claim 5, wherein a first transverse axis, extending through the first pivot joint, is vertically lower than a second transverse axis extending through an end of the second member proximate the track.

7. The compact utility vehicle of claim 6, wherein the second horizontal transverse axis is located vertically higher than the first horizontal transverse axis at least when the lift assembly is in the lowered position.

8. The compact utility vehicle of claim 5, wherein the first member is a single first member and the second member includes two second members pivotally connected to opposite sides of the single first member.

9. The compact utility vehicle of claim 1, wherein a front edge of the hopper moves in a forward direction when the lift assembly is operated from the lowered position towards the raised position.

10. The compact utility vehicle of claim 9, wherein, in the lowered position of the lift assembly, the front edge of the hopper is rearward of a front end of the chassis and wherein, in the raised position of the lift assembly, the front edge of the hopper is forward of the chassis front end.

11. The compact utility vehicle of claim 10, wherein the front edge of the hopper is moved at least 24 inches in a vertical direction from the lowered position to the raised position of the lift assembly.

12. A compact utility vehicle, comprising:
a) a chassis extending along a longitudinal axis and carrying a prime mover and ground engaging members;
b) a lift assembly supported by the chassis and being movable between a lowered position and a raised position via a first actuator, the lift assembly including a scissor linkage assembly supported by the chassis via a spring-biased roller and track arrangement and at a fixed first pivot joint; and
c) a hopper supported by the lift assembly and being pivotable with respect to the lift assembly between a dump position and a storage position via a second actuator.

13. The compact utility vehicle of claim 12, further comprising a control arrangement configured to actuate the first and second actuators to selectively raise and lower the hopper and to pivot the hopper between the storage and dump positions based on a user input.

14. The compact utility vehicle of claim 12, wherein the scissor linkage assembly includes a first member pivotally connected to a pair of second members, the first member being pivotally connected to the chassis at the first pivot joint, the pair of second members being supported by the roller and track arrangement.

15. The compact utility vehicle of claim 14, wherein the roller and track arrangement includes a pair of tracks associated with the chassis and a pair of roller assemblies mounted to ends of the second members and received by the pair of tracks.

16. The compact utility vehicle of claim 14, wherein the pair of roller assemblies includes a pair of rollers and a spring biasing at least one of the rollers in a direction that is orthogonal to a length of the pair of tracks.

17. The compact utility vehicle of claim 16, wherein each of the pair of rollers defines a groove receiving one of the pair of tracks.

18. A compact utility vehicle, comprising:
a) a chassis extending along a longitudinal axis and carrying a prime mover and ground engaging members, the chassis extending to a front end;
b) a lift assembly supported by the chassis and including a frame, a linkage assembly, and a first actuator, wherein the frame is movable between a lowered position and a raised position via the linkage assembly and first actuator, the frame defining a front face that is rearward of the chassis front end in the lowered position and that is forward of the chassis front end in the raised position; and
c) a hopper supported by the frame and being pivotable with respect to the frame about a pivot axis between a dump position and a storage position via a second actuator.

19. The compact utility vehicle of claim 18, wherein the pivot axis is forward of the chassis front end in both the lowered and raised positions of the frame.

20. The compact utility vehicle of claim 18, wherein a front edge of the hopper is forward of the chassis front end in both the lowered and raised positions of the frame.
